(19) United States
(12) Patent Application Publication
(10) Pub. No.: US 2026/0253134 A1
(43) Pub. Date: Aug. 27, 2026

(54) SYSTEMS, METHODS AND COMPUTER PROGRAM PRODUCTS FOR ORCHESTRATING PAYMENT SYSTEMS FOR CROSS-BORDER PAYMENTS

(71) Applicants: The Clearing House Payments Company L.L.C., New York, NY (US); ABE Clearing S.A.S. à capital variable, Paris (FR)

(72) Inventors: Stephen Kent LEDFORD, Winterville, GA (US); Irfan AHMAD, Mahweh, NJ (US); Yosselyn RAMOS, Bronx, NY (US); Petronella Margaretha Josephine PLOMPEN, Asperen (NL); Willem Hendrik KULK, Tervuren (BE)

(73) Assignees: The Clearing House Payments Company L.L.C., New York, NY (US); ABE Clearing S.A.S. à capital variable, Paris (FR)

(21) Appl. No.: 18/856,253

(22) PCT Filed: Jul. 8, 2022
(86) PCT No.: PCT/US2022/036573

§ 371 Date: Oct. 11, 2024

(30) Foreign Application Priority Data
Apr. 12, 2022 (FR) FR2203327

(51) Int. Cl. G06Q 40/02; G06Q 20/02; G06Q 20/10; G06Q 20/38

(52) U.S. Cl. CPC G06Q 40/022; G06Q 20/02; G06Q 20/10; G06Q 20/381; G06Q 40/02; G06Q 40/0225

(57) ABSTRACT

Methods, systems, and computer program products are provided for orchestrating financial transfer systems for cross-border payments. A cross-border settlement orchestrator receives an electronic payment message from a first financial transfer system and sends the electronic payment message to a first facilitator system The cross-border settlement orchestrator also converts the electronic payment message, which is sent to a second facilitator system and a second financial transfer system The cross-border settlement orchestrator further receives an electronic response message from the second financial transfer system in response to the converted electronic payment message. In turn, the cross-border settlement orchestrator sends an electronic settlement confirmation message to the second facilitator system. The cross-border settlement orchestrator further sends the electronic response message to the first financial transfer system and another electronic settlement confirmation message to the first facilitator system confirming settlement of a cross-border payment.

### CROSS REFERENCE TO RELATED APPLICATIONS

This application is being filed on Jul. 8, 2022, as a PCT International Patent application and claims the benefit of and priority to FR Patent Application No. 2203327, filed 12 Apr. 2022, the entire disclosure of which is incorporated by reference in its entirety.

### BACKGROUND

Example aspects of the present invention generally relate to electronic transactions, and more particularly to electronic real-time cross-border transactions.

A domestic payment is a payment where a bank or any other payment service provider (PSP) authorized by its customers to execute payments on behalf of customers where the bank of the payee and the bank of the payor are located in the same country or region (for example, two banks located in France, one holding a client's account and the other holding a merchant's account). The bank can issue or acquire corresponding payment instruments to such customers for this purpose or hold the corresponding payment account of the payor or payee as applicable.

A cross-border payment, in contrast with a domestic payment, refers to a transaction where the banks of the payor and the payee are established and operating in at least two different countries or regions that do not necessarily share a border (for example, a bank located in the member states of the European Union (EU) or in the countries or territories belonging to the Single European Payment Area (SEPA) and another bank located in the United States, one holding a client's account and the other holding a merchant's account). The notion of domestic payment or cross-border payment as outlined above shall not be understood as limited to direct payments between the banks of the payor and the payee. A single domestic or cross-border payment could, and in practice would generally, involve a series of inter-PSP payments between intermediary banks in a chain of payments. In this document, the terminology of “cross-border payments” will be used to refer to cross-border payments involving a pair or a longer chain of banks, which may involve at least one currency conversion, i.e. between banks located in different countries or regions having a different currency. With the increase of transactions occurring in virtual environments, the differences between domestic and cross-border provision of services and goods, on all levels, diminish.

Traditional cross-border payments, however, are seen as less efficient and more costly than domestic payments. Particularly, cross-border payments involving a currency conversion are more costly in terms of requiring relatively more money to effectuate a transaction and requiring increased computational cost in relation to, for example, the amount of time required of processors throughout the associated payment systems to complete computing operations. One reason cross-border payments are less efficient is that they involve various disparate payment systems including both physical parts as well as software (referred to also sometimes as payment networks, financial transfer systems, and the like) that are located in multiple locations. Payment systems located in different countries, for example, have different operational time windows resulting in significant time delays in processing cross-border payments. Another reason cross-border payments are more costly is that they rely on multiple intermediary participants. These intermediary participants can be located in multiple countries, typically charge fees to facilitate cross-border payments, may have varying processing rules both in terms of technical processing rules and regulatory rules, in addition to having to handle different exchange rates. Some banks and payment services providers (PSPs) (also referred to as facilitator systems, provider banks, and the like) have attempted to improve cross-border payment systems, but unfortunately with little improvement. One technical challenge they still face involves the orchestration of payment systems involved in cross-border payments.

Various countries or regions, such as the EU/SEPA, the United States (US), Singapore, South Africa, Sweden, Australia, and the United Kingdom (UK), have implemented real-time domestic payment systems. For instance, a so-called FAST PAYMENT service exists in the United Kingdom (UK), as does a Fast And Secure Transfers (FAST) service in Singapore. Both follow a typical model for providing immediate funds availability. For example, 97% of payment transactions are made available to a recipient within 60 seconds of receipt. For transactions not posted within 60 seconds, the payor of a transaction is informed that the transaction is under review. “Immediate” as used herein means “substantially immediate”, “instant” or “substantially instant”.

Other domestic payment systems include mobile payments systems and online payment systems, such as SWISH and PAYM mobile peer-to-peer (P2P) in Sweden and the UK, purportedly provide immediate notification and credit. ZELLE, CLEARXCHANGE, and POPMONEY in the U.S. purportedly provide immediate notification with deferred credit. VENMO and SQUARECASH purportedly provide immediate notification and immediate or deferred credit. However, none of those services actually provide real-time crediting and settlement capability. That is, they do not, for example, post funds immediately to a creditor's account.

Even though there exist different payment systems around the world, they have significant technical limitations when used to perform global cross-border payments. A cross-border payment involves at least two payment systems because each of these payment systems is only capable of processing payments in the country or region where it is located. For example, a first payment system in the country where the cross-border payment is originated has a first payment processor device that processes a first payment of the cross-border payment to a first provider bank. The first provider bank, which has its own payment processor device, operates as an intermediary service provider. A second payment system in another country where the cross-border payment is received has a second payment processor device that processes a second payment of the cross-border payment from a second provider bank. The second provider bank, which also has its own payment processor device, operates as another intermediary service provider.

One significant technical limitation is that the first payment processor device, the second payment processor device, the first provider bank's payment processor device, and the second provider bank's payment processor device are not capable of processing the cross-border payment in orchestration. Consequently, these non-orchestrated payment processor devices are not capable of reliably settling a cross-border payment. Each of these payment processor devices, functioning in a serial order, can individually or in various combinations be the cause of a significant operational failure, including technical failures, data loss, and result in conflicting messages, as well as create significant data security issues, and the like. Data security issues can arise, for example, because workflows for processing such errors may involve either the use of a less secure worker to perform a computing operation or task. Data security issues can also arise when a workflow is broken and troubleshooting the failure involves decryption of sensitive data. Further, in case of any operational failure, it is relatively difficult to locate where the failure happened or identify the status of the current cross-border payment.

In addition, because these multiple payment processor devices in different payment systems and different provider banks all need to perform processing operations on the transaction data, these operations slow down the computer servers and increase processing costs of each of these multiple payment processor devices. For instance, in addition to increasing the monetary cost of operating servers, these operations consume more energy, create more heat, and wear out computer hardware sooner than desired.

Also, these multiple payment processor devices in different payment systems and different provider banks all increase transactional costs of the cross-border payment because each of these payment processor devices processes a separate transaction essentially.

Another significant technical limitation is that some payment processor devices have different operational time windows as they are located in multiple countries in multiple time zones. Each of these payment processor devices not only operates differently, but also performs specific functions at different times. These different operational time windows delay transfers significantly when operations are normal (e.g., 24 to 48 hours), they also increase the likelihood of causing significant technical errors, which consequently result in either canceled or held cross-border payments. For example, one payment processor device performs specific tasks during specific time windows. When communicating to another payment processor device located in another time zone, the information being sent to the other payment processor device is being held in a buffer of the other payment processor device. The buffer can be overrun and thus can cause an internal buffer overflow signal to be generated. Thus, a cross-border payment potentially fails or is temporarily held for days until the other system reopens, delaying the transaction.

In summary, these multiple payment processor devices function together in a serial and non-orchestrated order, which contributes to segmented and opaque processes, uncertain processing time delays, high processing and transactional costs, and a significant likelihood of operational failures.

### SUMMARY

The foregoing cross-border orchestration problem and other limitations are overcome by systems, methods, and computer program products for orchestrating payment systems for immediate cross-border payments. Immediate cross-border payments are generally understood to be cross-border payments with at least one currency conversion in which the transmission of the payment message and the settlement of the corresponding payments occur in real time or near-real time on as near to a 24-hour and seven-day (24/7) basis as possible. In some embodiments, immediate cross-border payments are settled less than 30 minutes after the time of initiation. In other embodiments, immediate cross-border payments are settled less than 15 minutes after the time of initiation. In other embodiments, immediate cross-border payments are settled less than 60 seconds after the time of initiation. In further embodiments, a large volume of different payments or batch payments are settled during the same day.

The characteristics, in particular the speed but also the processing mode (e.g. individual payment processing or batch processing), of cross-border payments considered ‘immediate’ may vary from currency corridors to currency corridors or even pair of payment systems involved for a given corridor; it is for instance not excluded that fast but not immediate settlement of cross-border payments be used in the future similar orchestration systems, methods, and computer program products, e.g. settlement during the same business day.

Example aspects of the present invention address frictions identified in areas of speed, transparency, and costs of effectuating cross-border transactions. For example, a fully integrated and orchestrated approach removes the greatest number of frictions by facilitating atomic transaction processing meaning that a payment cannot succeed in one system and fail in the other, while keeping legal and regulatory coordination to support settlement across multiple jurisdictions. That is, an orchestrated settlement process is facilitated, ensuring that settlement will take place in all payment systems involved by a cross-border transaction. To achieve such an orchestrated settlement process, the example approach leverages real-time payment systems across multiple countries (which adopt, for example, a settlement model without processing lag and other variances of an assured delivery model).

In one embodiment, a system is provided for orchestrating financial transfer systems. The system includes a cross-border settlement orchestrator configured to receive an electronic payment message from a first financial transfer system, the electronic payment message including a first amount of a first payment in a first currency; and send the electronic payment message to a first facilitator system. The cross-border settlement orchestrator is also configured to convert the electronic payment message to a converted electronic payment message according to an exchange rate between the first currency and a second currency, the converted electronic payment message including a second amount of a converted payment in the second currency and the converted electronic payment message to be communicated to a destination account provider system; and send the converted electronic payment message to a second facilitator system. The cross-border settlement orchestrator is further configured to receive a first electronic response message from the first facilitator system and a second electronic response message from the second facilitator system, the first electronic response message responding to the electronic payment message sent to the first facilitator system and the second electronic response message responding to the converted electronic payment message sent to the second facilitator system; when the first electronic response message includes information accepting the electronic payment message and the second electronic response message includes information accepting the converted electronic payment message, send the converted electronic payment message to a second financial transfer system; and receive a third electronic response message from the second financial transfer system in response to the converted electronic payment message. The cross-border settlement orchestrator is further configured to send a second electronic confirmation message to the second facilitator system, the second electronic confirmation message confirming that the second financial transfer system has settled the converted payment; send the third electronic response message to the first financial transfer system, the third electronic response message to be communicated to the source account provider system; receive a first electronic confirmation message from the first financial transfer system, the first electronic confirmation message confirming that the first financial transfer system has settled the first payment; and send the first electronic confirmation message to the first facilitator system.

In some implementations, the cross-border settlement orchestrator is further configured to cause, by sending the converted electronic payment message, the destination account provider system to accept the converted payment of the second amount in the second currency, generate the third electronic response message, and communicate the third electronic response message to the second financial transfer system, thereby indicating to the second financial transfer system that the destination account provider system accepts the converted payment of the second amount in the second currency to be settled by the second financial transfer system.

In other implementations, the cross-border settlement orchestrator is further configured to cause, by sending the third electronic response message to the first financial transfer system, the first financial transfer system to settle the first payment of the first amount in the first currency to the first facilitator system from the source account provider system, and send the first electronic confirmation message to the cross-border settlement orchestrator.

In further implementations, the electronic payment message includes a quote for the exchange rate between the first currency and the second currency, the quote having been provided by the first facilitator system to the source account provider system.

In yet further implementations, the electronic payment message further includes a token identifying the quote, wherein the token includes the exchange rate between the first currency and the second currency, an expiration date of the quote, and a routing path of the quote, the routing path associating the quote with the first facilitator system and the second facilitator system.

In still further implementations, the cross-border settlement orchestrator is further configured to receive a first electronic recon message from the first financial transfer system when the first financial transfer system receives the third electronic response message, the first electronic recon message being configured to acknowledge that the first financial transfer system receives the third electronic response message from the cross-border settlement orchestrator; send the first electronic recon message to the first facilitator system; and send a second electronic recon message to the second facilitator system upon receiving the third electronic response message, the second electronic recon message being configured to acknowledge receiving the third electronic response message from the second financial transfer system.

In other implementations, the system further comprises a liquidity provision system, the liquidity provision system configured to be accessed by the first facilitator system and the second facilitator system.

In further implementations, the liquidity provision system is accessed by the first facilitator system and the second facilitator system using a blockchain system.

In another embodiment, there is provided a method for orchestrating financial transfer systems. The method includes receiving an electronic payment message from a first financial transfer system, the electronic payment message including a first amount of a first payment in a first currency; and sending the electronic payment message to a first facilitator system. The method also includes converting the electronic payment message to a converted electronic payment message according to an exchange rate between the first currency and a second currency, the converted electronic payment message including a second amount of a converted payment in the second currency and the converted electronic payment message to be communicated to a destination account provider system; and sending the converted electronic payment message to a second facilitator system. The method further includes receiving a first electronic response message from the first facilitator system and a second electronic response message from the second facilitator system, the first electronic response message responding to the electronic payment message sent to the first facilitator system and the second electronic response message responding to the converted electronic payment message sent to the second facilitator system; when the first electronic response message includes information accepting the electronic payment message and the second electronic response message includes information accepting the converted electronic payment message, sending the converted electronic payment message to a second financial transfer system; and receiving a third electronic response message from the second financial transfer system in response to the converted electronic payment message. The method further includes sending a second electronic confirmation message to the second facilitator system, the second electronic confirmation message confirming that the second financial transfer system has settled the converted payment; sending the third electronic response message to the first financial transfer system, the third electronic response message to be communicated to the source account provider system; receiving a first electronic confirmation message from the first financial transfer system, the first electronic confirmation message confirming that the first financial transfer system has settled the first payment; and sending the first electronic confirmation message to the first facilitator system.

In some implementations, the method further includes sending, by the cross-border settlement orchestrator, the converted electronic payment message to cause the destination account provider system to accept the converted payment of the second amount in the second currency, generate the third electronic response message, and communicate the third electronic response message to the second financial transfer system, thereby indicating to the second financial transfer system that the destination account provider system accepts the converted payment of the second amount in the second currency to be settled by the second financial transfer system.

In other implementations, the method further includes sending, by the cross-border settlement orchestrator, the third electronic response message to cause the first financial transfer system to settle the first payment of the first amount in the first currency to the first facilitator system from the source account provider system, and send the first electronic confirmation message to the cross-border settlement orchestrator.

In further implementations, the electronic payment message includes a quote for the exchange rate between the first currency and the second currency, the quote having been provided by the first facilitator system to the source account provider system.

In yet further implementations, the electronic payment message further includes a token identifying the quote, wherein the token includes the exchange rate between the first currency and the second currency, an expiration date of the quote, and a routing path of the quote, the routing path associating the quote with the first facilitator system and the second facilitator system.

In still further implementations, the method further includes receiving, by the cross-border settlement orchestrator, a first electronic recon message from the first financial transfer system when the first financial transfer system receives the third electronic response message, the first electronic recon message being configured to acknowledge that the first financial transfer system receives the third electronic response message from the cross-border settlement orchestrator; sending, by the cross-border settlement orchestrator, the first electronic recon message to the first facilitator system; and sending, by the cross-border settlement orchestrator, a second electronic recon message to the second facilitator system upon receiving the third electronic response message, the second electronic recon message being configured to acknowledge receiving the third electronic response message from the second financial transfer system.

In other implementations, the method further includes accessing a liquidity provision system by the first facilitator system and the second facilitator system.

In further implementations, the liquidity provision system is accessed by the first facilitator system and the second facilitator system using a blockchain system.

In yet another embodiment, there is provided a non-transitory computer-readable medium having stored thereon one or more sequences of instructions, which when executed by one or more processors, cause the one or more processors to perform the methods described herein. In particular, the non-transitory computer-readable medium has stored thereon one or more sequences of instructions, which when executed by one or more processors, cause the one or more processors to perform receiving, by a cross-border settlement orchestrator, an electronic payment message from a first financial transfer system, the electronic payment message including a first amount of a first payment in a first currency; sending the electronic payment message to a first facilitator system; converting the electronic payment message to a converted electronic payment message according to an exchange rate between the first currency and a second currency, the converted electronic payment message including a second amount of a converted payment in the second currency and the converted electronic payment message to be communicated to a destination account provider system; sending the converted electronic payment message to a second facilitator system; receiving a first electronic response message from the first facilitator system and a second electronic response message from the second facilitator system, the first electronic response message responding to the electronic payment message sent to the first facilitator system and the second electronic response message responding to the converted electronic payment message sent to the second facilitator system; when the first electronic response message includes information accepting the electronic payment message and the second electronic response message includes information accepting the converted electronic payment message, sending the converted electronic payment message to a second financial transfer system; receiving a third electronic response message from the second financial transfer system in response to the converted electronic payment message; sending a second electronic confirmation message to the second facilitator system, the second electronic confirmation message confirming that the second financial transfer system has settled the converted payment; sending the third electronic response message to the first financial transfer system, the third electronic response message to be communicated to the source account provider system; receiving a first electronic confirmation message from the first financial transfer system, the first electronic confirmation message confirming that the first financial transfer system has settled the first payment; and sending the first electronic confirmation message to the first facilitator system.

In some implementations, the non-transitory computer-readable medium has stored thereon one or more sequences of instructions, which when executed by one or more processors, cause the one or more processors to further perform sending the converted electronic payment message to cause the destination account provider system to accept the converted payment of the second amount in the second currency, generate the third electronic response message, and communicate the third electronic response message to the second financial transfer system, thereby indicating to the second financial transfer system that the destination account provider system accepts the converted payment of the second amount in the second currency to be settled by the second financial transfer system; and sending the third electronic response message to cause the first financial transfer system to settle the first payment of the first amount in the first currency to the first facilitator system from the source account provider system and reply with the first electronic confirmation message.

In other implementations, the non-transitory computer-readable medium has stored thereon one or more sequences of instructions, which when executed by one or more processors, cause the one or more processors to further perform receiving a first electronic recon message from the first financial transfer system when the first financial transfer system receives the third electronic response message, the first electronic recon message being configured to acknowledge that the first financial transfer system receives the third electronic response message; sending the first electronic recon message to the first facilitator system; and sending a second electronic recon message to the second facilitator system upon receiving the third electronic response message, the second electronic recon message being configured to acknowledge receiving the third electronic response message from the second financial transfer system.

In further implementations, the non-transitory computer-readable medium has stored thereon one or more sequences of instructions, which when executed by one or more processors, cause the one or more processors to further perform accessing a liquidity provision system using a blockchain system.

### BRIEF DESCRIPTION OF THE DRAWINGS

The features and advantages of the example embodiments of the invention presented herein will become more apparent from the detailed description set forth below when taken in conjunction with the following drawings.

FIG. 1 is a system diagram illustrating an example system and processes for orchestrating payment systems for immediate cross-border payments, in accordance with an embodiment.

FIG. 2 is a system flow diagram illustrating an example system and processes for orchestrating payment systems for immediate cross-border payments, in accordance with an embodiment.

FIG. 3 is a block diagram illustrating an example cross-border settlement orchestrator for orchestrating payment systems for immediate cross-border payments, in accordance with an embodiment.

FIG. 4 is a system diagram illustrating another example system for orchestrating payment systems for immediate cross-border payments, in accordance with an embodiment.

FIG. 5 illustrates an example computing system on which aspects of the present disclosure may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Generally, example aspects of the embodiments described herein provide systems, methods, and computer program products for orchestrating payment systems for cross-border transactions. More specifically, example aspects of the embodiments described herein leverage disparate real-time payment systems across multiple regions by orchestrating these real-time payment systems, and by processing payment messages (referred to also sometimes as request messages, transfer messages, and the like) and response messages (referred to also sometimes as confirmation messages, confirmation pages, notification messages, and the like) on behalf of intermediate banks. As used herein, a region refers to an individual country, a set of countries (e.g., the member states defined as the European Union (EU) or the countries and territories included in SEPA), or a jurisdiction.

Payment systems in different regions support multiple financial and non-financial message types that are used to create a variety of transaction flows in support of disparate use cases. Flexible and extensible message formats are employed to adapt to changing needs. This enables payment system flexibility for future needs, provides a platform for product development and innovation, and allows backward compatibility with another payment system such as the Automated Clearing House (ACH) payment system or the ABE CLEARING S.A.S. á capital variable's (EBA Clearing's) payment system. Messages may be overlaid to provide end-to-end solutions for specific use cases. A framework incorporating extensible messaging allows financial institutions (FIs) to create products independently for senders and receivers that can interoperate without the senders and receivers being required to coordinate with each other. In some embodiments, the extensible messaging that is incorporated includes both financial and non-financial messages.

In some example implementations, a message includes fields of data, external links, etc., and carry at least information necessary for effecting transactions in each payment system involved but could carry much more information as required or useful to be transmitted between the sending and the receiving banks. In some example implementations, a message includes a Universal Transaction Identification (ID) which is unique within a payment system for every transaction, as well as an identifier of a sending party (if applicable). In other implementations, a message includes amount, currency, bank identifier code (BIC) of sending/receiving banks, execution date.

The extensible messaging employed herein, in some embodiments, complies with existing global standard formats (e.g., ISO 20022, ISO 8583, etc.) and has international compatibility (e.g., multi-currency).

In some embodiments, a message is an FI-to-FI message. An FI-to-FI message communicates, for example, an acknowledgement by an FI that receives a payment, and/or payment details provided by an FI that initiates the payment.

In some embodiments, a message is an FI-to-end-user message. Examples of an FI-to-end-user message include a receiver notification message, a sender notification message, a successful payment message, a sender notification message for rejected payment, and a sender notification message for payment under review.

In some embodiments, a message is an end-to-end message. An end-to-end message can include, for example, a request for payment (e.g., an invoice or a message by which a payee requests a payment initiation, known also in SEPA as a request-to-pay), a receipt acknowledged by a receiver message, a request message for return or recall of funds, and a message to return or reverse funds (or agree thereto).

In some embodiments, a message is a third-party message. A third-party message can include, for example, a message of universal transaction identifier (ID), a message linking to an external source, and a contingency payment rule message.

In some embodiments, a message is a non-payment message. A non-payment message supports, in particular, answering to payment messages or handling errors with payment message flows, value-added services, or administration operations. A non-payment message also includes request to pay or request for payment message.

In some implementations, the above-described messages can be associated. For example, multiple messages of various types can be associated for more complex transactions. In another example, for extended functionality, associated messages can carry remittance data and references to external data and processes.

Example aspects of the embodiments described herein also leverage various types of standardized messaging protocols and other related technical building blocks. As a result, example implementations operate in compliance with various versions of these standardized messaging protocols and enable disparate systems to be integrated and stay integrated in the future.

Example implementations work with ISO 20022, which is a harmonized set of Extensible Markup Language (XML) messaging standards across major financial services domains (Funds Transfer, Cash, Securities, Trade, Card and Foreign Exchange) based on a shared data dictionary and business process model. Messages are available for the complete end-to-end payments chain: i.e., bank-to-bank, and reporting. Data definitions can be used as the basis for internal communication needs, and the standard can support real-time messaging (e.g., Denmark NETS). Examples of messages defined in ISO 20022 include Payments Clearing and Settlement (pacs) messages that denote XML messages used between banks, like the pacs.008 message for payment message and the pacs.002 message for notification. For instance, in example implementations, pacs. 008 messages defined in ISO 20022 are used as payment messages and pacs. 002 messages defined in ISO 20022 are used as response messages.

Example implementations also work with ISO 8583, which is a common interface by which financial transaction card originated messages may be interchanged between acquirers and card issuers. Messages in the standard typically contain information about the value of a transaction, where it originated, the card account number, and bank sort code. Message data fields can be customized, and the standard can support real-time messaging. The standard is used by retail banks, and for almost all credit and debit card transactions, including automated teller machines (ATMs).

In other implementations, messages in the standard contain bank identification number (BIN) or primary account number (PAN).

Example implementations integrate and orchestrate a cluster of processes and services to ensure that settlement will take place in all payment systems involved in a cross-border payment transaction with fewer failures and more transparency by using a cross-border settlement orchestrator. The cross-border settlement orchestrator is a technical real-time messaging and conversion processor which provides orchestration for cross-border payment systems. Orchestration is the automated configuration, management, and/or coordination of computer systems, applications, and/or services.

Orchestration enables complex systems to manage complex tasks and workflows more efficiently and reliably. The cross-border settlement orchestrator orchestrates payment systems by forwarding payment messages to and from a pair of cross-border account provider systems and converting payments messages initiated by a source account provider system into corresponding messages to be received by a destination account provider system.

By using the cross-border settlement orchestrator to orchestrate processes involved in cross-border payment transactions, example implementations solve or reduce issues of processing time delays, high processing costs, and the mismatch of operational time windows, etc.

For example, the timing of settling a first payment initiated by a payor of a cross-border payment transaction using a source account provider system (referred to also sometimes as a source account holder system, a source financial institution system, a sending bank system, an obligatory bank system, and the like), and the timing of settling a second payment received by a payee of the cross-border payment transaction using a destination account provider system (referred to also sometimes as a destination account holder system, a destination financial institution system, a receiving bank system, a beneficiary bank system, and the like), are orchestrated by a cross-border settlement orchestrator to minimize the risk of unrecoverable operational failures. In example implementations, the cross-border settlement orchestrator on behalf of facilitator systems, receives, encrypts, decrypts, validates, processes, converts, re-routes, forwards and/or repurposes messages communicated between the various payment systems involved in a cross-border transaction (for example, ISO 20022 pacs.008 messages and pacs.002 messages, etc.). Advantageously, example aspects of the embodiments described herein significantly increase the speed of cross-border transactions to push forward a chain of operation of effectuating immediate cross-border transactions. As a result, processing time delays and processing costs of cross-border transactions are reduced while the mismatch of operational time windows is reconciled.

Example aspects of the embodiments provided herein also provide a settlement process that settles the second payment before settling the first payment. The settlement process enables committed service levels to be met as well as timely and transparent execution of cross-border transactions to be significantly improved. The settlement process of payments begins when the destination account provider system accepts the second payment made to the destination account provider system, and the second payment settles without issues. The settlement process of payments completes when the source account provider system receives confirmation that the destination account provider system has accepted the second payment, and a first payment made from the source account provider system settles without issues. Even in case of an operational failure of the cross-border payment, the status of the cross-border payment and where the operational failure has happened along the chain of operation can be located and observed. Also, the first payment made from the source account provider system, which is the initiator of the cross-border payment, has not been settled yet. As a result, the initiator of the cross-border payment is enabled by the cross-border settlement orchestrator to undo the cross-border payment without incurring additional losses.

Example aspects also provide pre-validation that is performed to correct exceptions prior to initiating a payment.

In example implementations, messages are converted across multiple payment systems located in multiple countries to reduce payment exceptions and failures. Information is exchanged to provide real-time data simultaneously (e.g., in parallel, or substantially in parallel) to all participating institutions so that issues brought by the serial and opaque nature of operation are much alleviated.

Example aspects also provide that funds involved in the immediate cross-border transaction are earmarked (sometimes also referred to as reservation or blocking of funds) to ensure sufficient inter-bank liquidity to enable settlements at both ends of the source and destination account provider systems.

In addition to orchestration of settlements to improve the execution throughout the chain of operation effectuating an immediate cross-border transaction, other value propositions and benefits of example aspects of the embodiments provided herein include improved user experience in speed and transparency, the possibility of incurring lower transactional costs, the openness of allowing competition on services, and the support for cross-currency as well as, with some changes, single-currency payments.

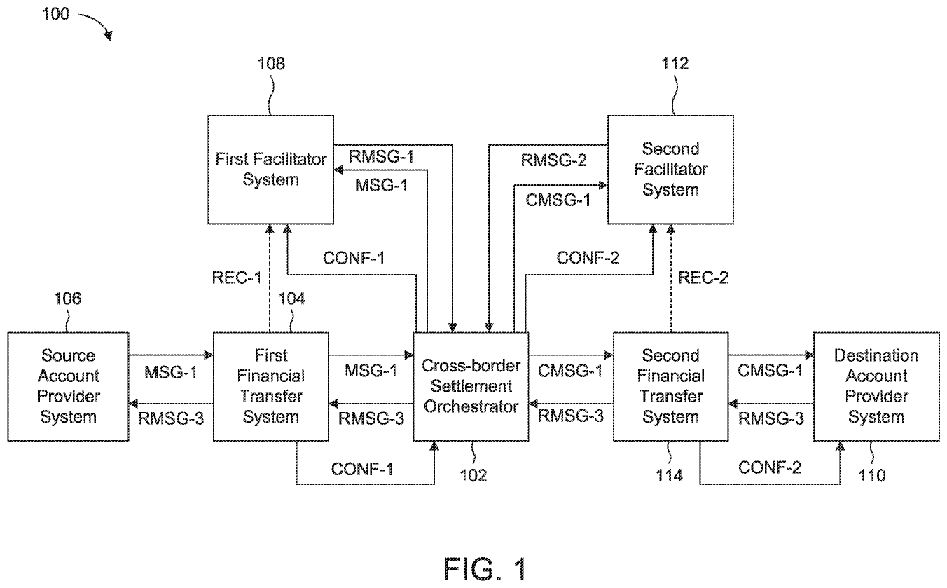

FIG. 1 illustrates an example system 100 for orchestrating payment systems for immediate cross-border payments. In one embodiment, the system 100 includes a cross-border settlement orchestrator 102, a first financial transfer system 104, a source account provider system 106, a first facilitator system 108, a second facilitator system 112, a second financial transfer system 114, and a destination account provider system 110. The source account provider system 106, the first facilitator system 108, the second facilitator system 112, and the destination account provider system 110 are systems that process actions of account servicing payment service providers (ASPSPs). An ASPSP is a financial institution that provides a payment account with online access. An account provider system as used herein may refer to the source account provider system 106 and/or destination account provider system 110. An account provider system implements application programming interfaces (APIs) with access to financial data, which enables trusted third parties to view and initiate payments with the user's consent. In some embodiments, the source account provider system 106 processes actions of an originating ASPSP, which initiates financial transactions for its users. In other embodiments, the destination account provider system 110 processes actions of a receiving ASPSP, which receives financial transactions for its users.

The cross-border settlement orchestrator 102 is a technical real-time messaging and conversion processor which provides orchestration for cross-border payment systems. Orchestration is the automated configuration, management, and/or coordination of computer systems, applications, and/or services. Orchestration enables complex systems to manage complex tasks and workflows more efficiently and reliably. The cross-border settlement orchestrator 102 orchestrates payment systems by forwarding payment messages to and from a pair of cross-border account provider systems and converting payments messages initiated by the source account provider system 106 into corresponding messages to be received by the destination account provider system 110.

In the illustrated example shown by FIG. 1, the source account provider system 106 is configured to initiate a process of sending information associated with a first payment in the currency of a first country or first region. Generally, this is accomplished by the source account provider system 106 generating and communicating an electronic payment message MSG-1, the details of which are described below in more detail. As noted above, as used herein, a region can be used to refer to an individual country, a set of countries (e.g., the member states defined as the European Union (EU), or a jurisdiction.

In some examples, the initiation of the first payment is upon the request of a payor that holds an account in the source account provider system 106. The source account provider system 106 is operated by a financial institution participant in the first financial transfer system 104 that initiates an immediate cross-border payment in its domestic currency for its customer.

In some embodiments, the source account provider system 106 is operated by a financial institution which is not a participant of the first financial transfer system 104. Messages sent by the source account provider system 106 are handled in the system 100 by another financial institution participant of the first financial transfer system 104 which represents the source account provider system 106.

In some embodiments, the destination account provider system 110 is operated by a financial institution which is not a participant of the second financial transfer system 114. Messages sent by the destination account provider system 110 are handled in the system 100 by another financial institution participant of the second financial transfer system 114 which represents the destination account provider system 110.

Prior to the request for the first payment (referred to herein as a payment initiation), the source account provider system 106 is configured to retrieve a foreign exchange rate to be used in the cross-border currency conversion process corresponding to the particular transaction. The cross-border currency conversion process corresponding to the particular transaction is referred to herein sometimes as a current immediate cross-border currency conversion. In some examples, the source account provider system 106 sends a request for a foreign exchange quote on the corresponding foreign exchange rate to a foreign exchange system (not shown). The first facilitator system 108 is operated by another financial institution participant in the first financial transfer system 104. The first facilitator system 108 sends a foreign exchange offer to the foreign exchange system. With the foreign exchange offer, the first facilitator system 108 sends a non-fixed value corresponding to the foreign exchange offer. In the message communicating the foreign exchange offer, the first facilitator system 108 provides the foreign exchange rate to be used in the current immediate cross-border currency conversion. When the foreign exchange quote from the source account provider system 106 is matched with the foreign exchange offer from the first facilitator system 108, the source account provider system 106 receives information from the foreign exchange system. In turn, the non-fixed value corresponding to the foreign exchange offer is set to a fixed value corresponding to the foreign exchange quote. The information received by the source account provider system 106 includes, for example, the exchange rate, an ID of the foreign exchange quote, an expiration date of the foreign exchange quote, and a routing path for the foreign exchange quote. The routing path for the foreign exchange quote includes information that defines a path for electronic messages, which contain information corresponding to the foreign exchange quote, to be routed from the first facilitator system 108 to the second facilitator system 112. The routing path includes information indicating that the first facilitator system 108 is associated with the quote. The routing path further includes information about the second facilitator system 112 associating the second facilitator system 112 with the quote, too. In some implementations, the routing path includes an electronic statement to indicate that electronic messages containing information about the foreign exchange quote are to be routed to the second facilitator system 112 from the first facilitator system 108. In other implementations, the routing path includes electronic tabulated information to indicate a series of electronic communication routes. The series of electronic communication routes define how electronic messages containing information about the foreign exchange quote are to be routed to the second facilitator system 112 from the first facilitator system 108.

In some examples, the information about the foreign exchange quote received by the source account provider system 106 is contained in a tamper-resistant hashed token reflecting the corresponding information including those discussed above.

In some examples, the source account provider system 106 also uses a pre-validation process to ensure payment success. In other examples, the source account provider system 106 also sends the information regarding the foreign exchange quote to the initiator of the first payment.

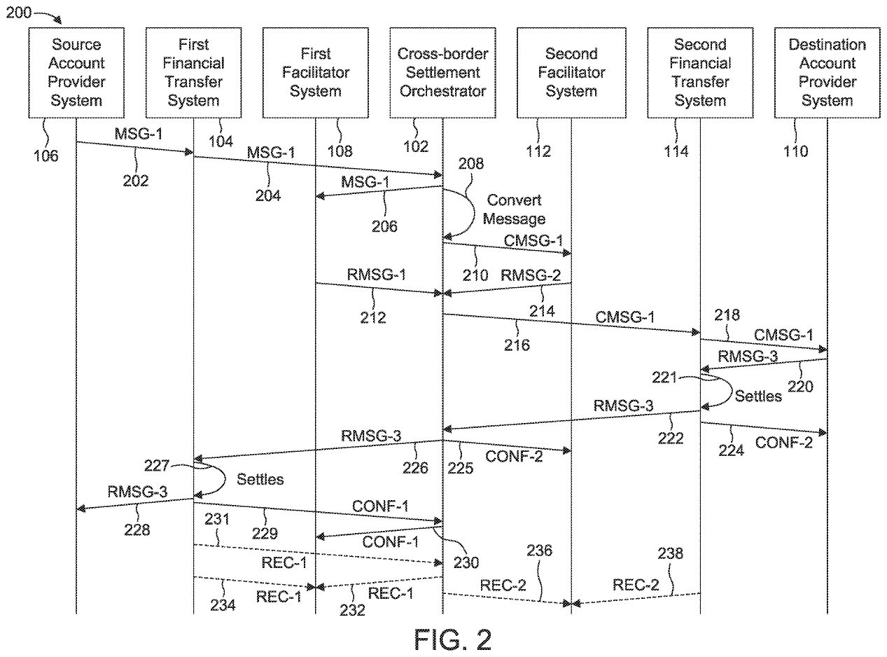

The source account provider system 106 is configured to send an electronic payment message MSG-1 (for instance, a pacs.008 message defined in ISO 20022) to the first financial transfer system 104 when initiating the first payment. The electronic payment message MSG-1, in an example implementation, specifies the first payment to be of a first amount in a first currency and other information. Examples of additional information contained within the electronic payment message MSG-1 includes data to identify the payment as an immediate cross-border payment, to add account details of the destination account provider system 110, and to specify the foreign exchange rate and the quote ID. The first financial transfer system 104 is configured to clear and settle the payment from the source account provider system 106 to the first facilitator system 108 after the completion of certain processes as described in FIG. 1 and FIG. 2. By receiving the electronic payment message MSG-1, the first financial transfer system 104 also supports identifying the payment as an immediate cross-border payment. In some examples, the electronic payment message MSG-1 includes account details of the destination account provider system 110. In other examples, the electronic payment message MSG-1 includes information regarding the foreign exchange rate and the quote ID.

The first financial transfer system 104 is configured to, in turn, send the electronic payment message MSG-1 to the cross-border settlement orchestrator 102.

The cross-border settlement orchestrator 102 can include one or more processors communicatively coupled to one or more non-transitory memories storing instructions which when executed by the one or more processors, cause the one or more processors to operate to effect immediate cross-border payments. In some examples, the cross-border settlement orchestrator 102 is configured to receive information regarding the first payment from the first financial transfer system 104 to the first facilitator system 108. The cross-border settlement orchestrator 102 is configured to execute format and currency conversion corresponding to the first payment. The cross-border settlement orchestrator 102 also is configured to trigger a process associated with initiating a converted payment on the second financial transfer system 114 from the second facilitator system 112 to the destination account provider system 110.

The cross-border settlement orchestrator 102, in some embodiments, is configured to send the electronic payment message MSG-1 to the first facilitator system 108 providing all information regarding the first payment.

The cross-border settlement orchestrator 102 receives a first electronic response message RMSG-1 from the first facilitator system 108 confirming (for example, acknowledging, accepting, or declining) the initiated immediate cross-border payment.

In some examples, the first financial transfer system 104 also supports different processing times for immediate cross-border payment than for domestic payments. The cross-border settlement orchestrator 102 can use these processing times to coordinate the timing of operations of the first financial transfer system 104 and other systems. An electronic communication timeout is a mechanism that triggers when an electronic message sent from a source system does not receive a response from a destination system within a predetermined timeframe as defined by a corresponding protocol. For instance, when the first financial transfer system 104 sends out the electronic payment message MSG-1 and does not receive the expected response within a predetermined timeframe as defined by an electronic communication protocol corresponding to the immediate cross-border payment, a timeout mechanism of the first financial transfer system 104 is configured to abort the immediate cross-border payment corresponding to the electronic payment message MSG-1. However, the second financial transfer system 114, in this example, has a longer predetermined timeframe to respond to electronic messages corresponding to the immediate cross-border payment. As a result, the immediate cross-border payment is aborted by the first financial transfer system 104 while the second financial transfer system 114 is still processing the immediate cross-border payment.

Thus, it would be advantageous to be able to pass control of when the first financial transfer system 104 times out. In some implementations, the first financial transfer system 104 passes the control, which defines when the immediate cross-border payment transaction will time out at the first financial transfer system 104, to the second financial transfer system 114 through the cross-border settlement orchestrator 102. In passing the control of when the immediate cross-border payment transaction times out, the first financial transfer system 104 suspends its own mechanism of timing out the immediate cross-border payment transaction until it receives corresponding responses from the second financial transfer system 114. In other implementations, the cross-border settlement orchestrator 102 coordinates the timing of operations of different payment systems by monitoring the first financial transfer system 104 and the second financial transfer system 114 and making adjustment accordingly. For instance, when both of the first financial transfer system 104 and the second financial transfer system 114 do not respond within a certain timeframe, the cross-border settlement orchestrator 102 triggers a mechanism to time out and cancels the transaction.

To accomplish communications with the second facilitator system 112, the cross-border settlement orchestrator 102 converts the electronic payment message MSG-1 to a converted electronic payment message CMSG-1 (for example, by converting a pacs.008 message, thereby generating a converted pacs.008 message).

The converted electronic payment message CMSG-1 includes information specifying the converted payment to be of a second amount in a second currency and other conversion information.

In some embodiments, the electronic payment message MSG-1 received by the cross-border settlement orchestrator 102 includes the information about the foreign exchange quote received by the source account provider system 106. The cross-border settlement orchestrator 102 uses the information about the foreign exchange quote received by the source account provider system 106 when the cross-border settlement orchestrator 102 converts the electronic payment message MSG-1 to the converted electronic payment message CMSG-1.

The cross-border settlement orchestrator 102 is configured to send the converted electronic payment message CMSG-1 to the second facilitator system 112. The converted payment message CMSG-1 provides all information regarding the converted payment.

The cross-border settlement orchestrator 102 is also configured to receive a second electronic response message RMSG-2 from the second facilitator system 112. The second electronic response message RMSG-2 includes information confirming (for example, acknowledging, accepting, or declining) the current immediate cross-border payment. The second facilitator system 112 is operated by a financial institution participant in the second financial transfer system 114.

In some embodiments, the second facilitator system 112 is configured to send the converted payment to the destination account provider system 110 operated by a service provider in the current immediate cross-border transaction.

In yet other embodiments, the second facilitator system 112 is configured to provision liquidity in the second financial transfer system 114.

In some examples, the first facilitator system 108 and the second facilitator system 112 have an arrangement on liquidity provision on the second financial transfer system 114 as well as any necessary settlement mechanism between the two facilitator systems for such liquidity. For instance, the second facilitator system 112 can be the same bank, banking group or other entity as the first facilitator system 108. In the chain of operation effectuating the immediate cross-border payment, both of the first facilitator system 108 and the second facilitator system 112 are configured to receive information corresponding to the payment from the cross-border settlement orchestrator 102, perform necessary compliance checking (for example, Financial Action Task Force (FATF), Anti-Money Laundering (AML), etc.), check the foreign exchange rate of the quote, and send acknowledging confirmation to the cross-border settlement orchestrator 102.

After receiving confirmation of acceptance from both the first facilitator system 108 and the second facilitator system 112, the cross-border settlement orchestrator 102 is configured to send the converted electronic payment message CMSG-1 to the second financial transfer system 114. The second financial transfer system 114 is configured to clear and settle the converted payment from the second facilitator system 112 to the destination account provider system 110. By receiving the converted electronic payment message CMSG-1, the second financial transfer system 114 supports identifying the payment as an immediate cross-border payment. In some examples, the converted electronic payment message CMSG-1 includes account details of the source account provider system 106. In other examples, the converted electronic payment message CMSG-1 includes information regarding the foreign exchange rate and the quote ID.

In some examples, the second financial transfer system 114 also supports different processing times for immediate cross-border payment than for domestic payments. This enables the cross-border settlement orchestrator 102 to coordinate the timing of operations of the second financial transfer system 114 and other systems.

When triggering the process associated with converting the first payment to the converted payment, the cross-border settlement orchestrator 102 complies to all requirements adopted by the second financial transfer system 114. This operation includes, in some embodiments, performing currency conversion operations based on the foreign exchange quote received from, for example, the foreign exchange system. This also can involve determining whether the second facilitator system 112 has approved the foreign exchange quote offered by the first facilitator system 108. As explained above, this involves communicating messages to and receiving messages from the second facilitator system 112.

In some embodiments, the cross-border settlement orchestrator 102 supports requirements adopted by the second financial transfer system 114 including formatting electronic communications sent to the second financial transfer system 114. In yet other embodiments, the cross-border settlement orchestrator 102 supports requirements adopted by the second financial transfer system 114 including routing electronic communications to the second financial transfer system 114 based on account data of the destination account provider system 110.

The second financial transfer system 114 also is configured to, in turn, send the converted electronic payment message CMSG-1 to the destination account provider system 110. The destination account provider system 110 is operated by a financial institution participant in the second financial transfer system 114. In some examples, the destination account provider system 110 receives the immediate cross-border payment in its domestic currency for its customer. The destination account provider system 110 is configured to receive the converted payment on the second financial transfer system 114 from the second facilitator system 112, via the cross-border settlement orchestrator 102. The destination account provider system 110 is also configured to receive additional information associated with the converted payment. In some examples, the additional information associated with the converted payment identifies that the converted payment is an immediate cross-border payment. In other examples, the additional information associated with the converted payment includes account details of the source account provider system 106 and account details of the second facilitator system 112. In yet other examples, the additional information associated with the converted payment includes the foreign exchange rate and the quote ID, etc.

Destination account provider system 110 is further configured to send a third electronic response message RMSG-3 to the second financial transfer system 114 confirming (for example, acknowledging, accepting, or declining) the immediate cross-border payment. The third electronic response message RMSG-3 includes information corresponding to the immediate cross-border payment received by the destination account provider system 110. In some examples, the third electronic response message RMSG-3 is a pacs.002 message defined in ISO 20022. In other examples, the third electronic response message RMSG-3 is also sent to the customer of the destination account provider system 110 including information regarding the immediate cross-border payment. In yet other examples, the destination account provider system 110 handles the immediate cross-border payment with different processing times than for domestic payments.

When the third electronic response message RMSG-3 sent by the destination account provider system 110 indicates acceptance of the immediate cross-border payment, the second financial transfer system 114 is configured to settle the converted payment from the second facilitator system 112 to the destination account provider system 110. In turn, the second financial transfer system 114 is configured to send the third electronic response message RMSG-3 to the cross-border settlement orchestrator 102. In some examples, the second financial transfer system 114 is also configured to send a second electronic confirmation message CONF-2 back to the destination account provider system 110 confirming the settlement of the converted payment on the second financial transfer system 114. The second electronic confirmation message CONF-2 includes information corresponding to the immediate cross-border payment received by the destination account provider system 110. In example implementations, the second electronic confirmation message CONF-2 is a pacs.002 message defined in ISO 20022.

On receiving the third electronic response message RMSG-3 from the second financial transfer system 114, the cross-border settlement orchestrator 102 is configured to send the third electronic response message RMSG-3 to the first financial transfer system 104. The cross-border settlement orchestrator 102 processes messages on behalf of the first facilitator system 108 on the first financial transfer system 104. In some examples, the cross-border settlement orchestrator 102 is also configured to convert the third electronic response message RMSG-3 as necessary before sending it to the first financial transfer system 104.

In some embodiments, after the second financial transfer system 114 sends the second electronic confirmation message CONF-2 to the destination account provider system 110, the cross-border settlement orchestrator 102 is also configured to send the second electronic confirmation message CONF-2 to the second facilitator system 112 upon receiving the third electronic response message RMSG-3 from the second financial transfer system 114. The second electronic confirmation message CONF-2 sent by the cross-border settlement orchestrator 102 is configured to confirm the settlement of the converted payment on the second financial transfer system 114.

When the third electronic response message RMSG-3 from the cross-border settlement orchestrator 102 indicates acceptance of the immediate cross-border payment, the first financial transfer system 104 is configured to settle the first payment to the first facilitator system 108 from the source account provider system 106. By design of the orchestrated settlement as described herein, the settlement of the first payment to the first facilitator system 108 from the source account provider system 106 via the cross-border settlement orchestrator 102 only happens after successful settlement by the second financial transfer system 114 of the converted payment from the second facilitator system 112 to the destination account provider system 110 via the cross-border settlement orchestrator 102.

In some examples, the first financial transfer system 104 is also configured to send a first electronic confirmation message CONF-1 back to the cross-border settlement orchestrator 102 confirming the settlement of the first payment on the first financial transfer system 104. The first electronic confirmation message CONF-1 includes information corresponding to the immediate cross-border payment paid by the source account provider system 106. In example implementations, the first electronic confirmation message CONF-1 is a pacs. 002 message defined in ISO 20022.

In some embodiments, the cross-border settlement orchestrator 102 sends the second electronic confirmation message CONF-2 to the second facilitator system 112 (step 225) after the cross-border settlement orchestrator 102 receives the first electronic confirmation message CONF-1 from the first financial transfer system 104 (step 229). The second electronic confirmation message CONF-2 from the cross-border settlement orchestrator 102 includes information contained in the first electronic confirmation message CONF-1 sent to the cross-border settlement orchestrator 102.

In some embodiments, the cross-border settlement orchestrator 102 is also configured to send the first electronic confirmation message CONF-1 to the first facilitator system 108 confirming the settlement of the first payment on the first financial transfer system 104.

In turn, the first financial transfer system 104 is configured to send the third electronic response message RMSG-3 to the source account provider system 106. In some examples, the first financial transfer system 104 sends the third electronic response message RMSG-3 to the source account provider system 106 concurrently with sending the first electronic confirmation message CONF-1. In some examples, the first financial transfer system 104 is also configured to send the source account provider system 106 any necessary extra data as relevant for the immediate cross-border payment in the confirmation.

The source account provider system 106 is configured to process the confirmation after successful settlement of the converted payment on the second financial transfer system 114 and the first payment on the first financial transfer system 104 (e.g., the successful completion of the immediate cross-border payment). The source account provider system 106 supports processing any necessary extra data as relevant for the immediate cross-border payment sent by the source account provider system 106. In some examples, the source account provider system 106 is also configured to send information update to the end-user, which initiated the immediate cross-border payment with the source account provider system 106. In other examples, the source account provider system 106 supports different processing times for immediate cross-border payment than for domestic payments.

When the acceptance of the immediate cross-border payment cannot be obtained at any point in the aforementioned chain of operation, the cross-border settlement orchestrator 102, the first financial transfer system 104, the source account provider system 106, the first facilitator system 108, the second facilitator system 112, the second financial transfer system 114, and the destination account provider system 110 are all configured to handle the non-acceptance as an operation exception. For instance, the destination account provider system 110 may find that account details of the end user receiving the immediate cross-border payment is incorrect. With the exception being handled, there are options to locate where the exception has happened, to correct needed information, or to undo the immediate cross-border payment when the error cannot be fixed practically. Other examples of exceptions that can be handled by the cross-border settlement orchestrator 102, in some embodiments, include flows having errors or exceptions, investigations, returns, and specific data in messages (e.g., different error codes and routing path information).

In another embodiment, the system 100 implements reconciliation messages (for example, an acknowledgement message, referred to herein as a recon message or a 5th leg pacs.002 messages defined in ISO 20022) to communicate the acknowledgement of the receipt of electronic confirmation messages (for example, pacs.002 messages defined in ISO 20022 or the third electronic response message RMSG-3). The first financial transfer system 104, upon receipt of the third electronic response message RMSG-3 from the cross-border settlement orchestrator 102, is configured to send a first electronic recon message REC-1 to the cross-border settlement orchestrator 102 and the first facilitator system 108. The first electronic recon message REC-1 from the first financial transfer system 104 acknowledges the receipt of the third electronic response message RMSG-3 by the first financial transfer system 104 from the cross-border settlement orchestrator 102. In some examples, the cross-border settlement orchestrator 102 is configured to relay the first electronic recon message REC-1 from the first financial transfer system 104 to the first facilitator system 108. Hence, the first electronic recon message REC-1 is propagated indirectly from the first financial transfer system 104 to the first facilitator system 108, via the cross-border settlement orchestrator 102. In other examples, the first financial transfer system 104 is configured to directly send the first electronic recon message REC-1 to the first facilitator system 108.

The cross-border settlement orchestrator 102 is configured to receive the first electronic recon message REC-1 and send a second electronic recon message REC-2. In some examples, the cross-border settlement orchestrator 102 sends the second electronic recon message REC-2 to the second facilitator system 112. In other examples, the second financial transfer system 114 sends the second electronic recon message REC-2 to the second facilitator system 112. In other examples, the cross-border settlement orchestrator 102 sends the second electronic recon message REC-2 to the second financial transfer system 114. In further examples, the second financial transfer system 114 also sends the second electronic recon message REC-2 to the destination account provider system 110.

In yet another embodiment, the first financial transfer system 104 and the second financial transfer system 114 are configured to earmark funds, which are involved in the current immediate cross-border payment, in their respective payment systems. Therefore, sufficient inter-bank liquidity is ensured to enable settlement at both ends of the destination account provider system 110 and the source account provider system 106.

In yet another embodiment, the cross-border settlement orchestrator 102 is configured to orchestrate the system 100 for sending and receiving immediate cross-border requests for payment in addition to sending and receiving immediate cross-border payments. For example (not shown in FIG. 1), the destination account provider system 110 initiates and sends a request for payment. The request for payment is received by the second financial transfer system 114, which in turn sends the request for payment to the cross-border settlement orchestrator 102. The cross-border settlement orchestrator 102, in turn, sends the request for payment to the first financial transfer system 104, which sends the request for payment to be received by the source account provider system 106.

FIG. 2 is system flow diagram illustrating an example system 200 and processes for orchestrating payment systems for immediate cross-border payments. In one embodiment, the system 200 includes the cross-border settlement orchestrator 102, the first financial transfer system 104, the source account provider system 106, the first facilitator system 108, the second facilitator system 112, the second financial transfer system 114, and the destination account provider system 110. Example methods, which include multiple steps of processes, are also illustrated and described in FIG. 2. At step 202, the source account provider system 106 sends the electronic payment message MSG-1 (for instance, a pacs.008 message defined in ISO 20022) to the first financial transfer system 104. In some embodiments, the electronic payment message MSG-1 carries information specifying a first payment to be of a first amount in a first currency and other information. Examples of other information carried by the electronic payment message MSG-1 includes a payment identifier (ID) identifying the payment as an immediate cross-border payment. Other information carried by the electronic payment message MSG-1 can include account details of the destination account provider system 110. Yet other information carried by the electronic payment message MSG-1 includes information specifying a foreign exchange rate and a quote ID. At step 204, the first financial transfer system 104 sends the electronic payment message MSG-1 to the cross-border settlement orchestrator 102.

The first payment specified by the electronic payment message MSG-1 is from the source account provider system 106 to the first facilitator system 108, via the cross-border settlement orchestrator 102. The cross-border settlement orchestrator 102 operates on behalf of the first facilitator system 108. As such, at step 206, the cross-border settlement orchestrator 102 sends the electronic payment message MSG-1, which the cross-border settlement orchestrator 102 receives from the first financial transfer system 104 as shown in step 204, to the first facilitator system 108. At step 208, the cross-border settlement orchestrator 102 converts the electronic payment message MSG-1 to the converted electronic payment message CMSG-1 (for example, a converted pacs.008 message) specifying a converted payment to be of a second amount in a second currency and other conversion information. The converted payment specified by the converted electronic payment message CMSG-1 is to the destination account provider system 110 from the second facilitator system 112, via the cross-border settlement orchestrator 102. The cross-border settlement orchestrator 102 operates on behalf of the second facilitator system 112. As such, at step 210, the cross-border settlement orchestrator 102 sends the converted electronic payment message CMSG-1, which has been converted from the electronic payment message MSG-1 for a second country or jurisdiction involved in the immediate cross-border payment, to the second facilitator system 112.

At step 212, the cross-border settlement orchestrator 102 receives from the first facilitator system 108 the first electronic response message RMSG-1 confirming (for example, acknowledging, accepting, or declining) the initiated immediate cross-border payment. At step 214, the cross-border settlement orchestrator 102 receives the second electronic response message RMSG-2 from the second facilitator system 112 confirming (for example, acknowledging, accepting, or declining) the initiation of the immediate cross-border payment in the second country or jurisdiction. When the first electronic response message RMSG-1 indicates acceptance by the first facilitator system 108 and the second electronic response message RMSG-2 indicates acceptance by the second facilitator system 112, the cross-border settlement orchestrator 102 sends the converted electronic payment message CMSG-1 to the second financial transfer system 114, at step 216.

In some embodiments, the cross-border settlement orchestrator 102 sends the electronic payment message MSG-1 to the first facilitator system 108 (step 206) before the cross-border settlement orchestrator 102 sends the converted electronic payment message CMSG-1 to the second facilitator system 112 (step 210). In other embodiments, the cross-border settlement orchestrator 102 processes step 210 before step 206. In further embodiments, the cross-border settlement orchestrator 102 processes step 206 and step 210 in a substantially simultaneous manner.

In some embodiments, the cross-border settlement orchestrator 102 receives the first electronic response message RMSG-1 from the first facilitator system 108 (step 212) before the cross-border settlement orchestrator 102 receives the second electronic response message RMSG-2 from the second facilitator system 112 (step 214). In other embodiments, the cross-border settlement orchestrator 102 processes step 214 before step 212. In further embodiments, the cross-border settlement orchestrator 102 processes step 212 and step 214 in a substantially simultaneous manner.

At step 218, the second financial transfer system 114 sends the converted electronic payment message CMSG-1, which the cross-border settlement orchestrator 102 sends to the second financial transfer system 114, to the destination account provider system 110. At step 220, the destination account provider system 110 sends the third electronic response message RMSG-3 to the second financial transfer system 114 confirming (for example, acknowledging, accepting, or declining) the immediate cross-border payment. The third electronic response message RMSG-3 includes relevant information for the immediate cross-border payment in the confirmation. In some examples, the third electronic response message RMSG-3 is a pacs.002 message defined in ISO 20022.

Upon the receipt of the third electronic response message RMSG-3 by the second financial transfer system 114, as shown in step 220, the second financial transfer system 114 settles the converted payment to the destination account provider system 110 from the second facilitator system 112, via the cross-border settlement orchestrator 102, at step 221. In turn, the second financial transfer system 114 sends the third electronic response message RMSG-3 to the cross-border settlement orchestrator 102 at step 222. In some examples, the second financial transfer system also sends the second electronic confirmation message CONF-2 back to the destination account provider system 110 at step 224.

After receiving the third electronic response message RMSG-3 from the second financial transfer system 114, as shown in step 222, the cross-border settlement orchestrator 102 also sends the second electronic confirmation message CONF-2 to the second facilitator system 112 at step 225, confirming the settlement of the converted payment on the second financial transfer system 114.

In turn, the cross-border settlement orchestrator 102 sends the third electronic response message RMSG-3 to the first financial transfer system 104 at step 226. In turn, at step 227, the first financial transfer system 104 settles the first payment from the source account provider system 106 to the first facilitator system 108, via the cross-border settlement orchestrator 102. After the settlement of the first payment, the first financial transfer system 104 sends the third electronic response message RMSG-3 to the source account provider system 106 at step 228.

In some embodiments, the cross-border settlement orchestrator 102 sends the third electronic response message RMSG-3 to the first financial transfer system 104 (step 226) before the cross-border settlement orchestrator 102 sends the second electronic confirmation message CONF-2 to the second facilitator system 112 (step 225). In other embodiments, the cross-border settlement orchestrator 102 processes step 225 before step 226. In further embodiments, the cross-border settlement orchestrator 102 processes step 225 and step 226 in a substantially simultaneous manner.

In some embodiments, the first financial transfer system 104 sends the third electronic response message RMSG-3 to the source account provider system 106 (step 228) before the first financial transfer system 104 sends the first electronic confirmation message CONF- 1to the cross-border settlement orchestrator 102 (step 229). In other embodiments, the first financial transfer system 104 processes step 229 before step 228. In further embodiments, the first financial transfer system 104 processes step 228 and step 229 in a substantially simultaneous manner.

In some examples, after the settlement of the first payment as shown in step 227, the first financial transfer system 104 sends the first electronic confirmation message CONF-1 back to the cross-border settlement orchestrator 102 at step 229. In turn, the cross-border settlement orchestrator 102 sends the first electronic confirmation message CONF-1 to the first facilitator system 108 at step 230, confirming the settlement of the first payment on the first financial transfer system 104.

In some embodiments, the cross-border settlement orchestrator 102 sends the first electronic confirmation message CONF-1 to the first facilitator system 108 (step 230) before the cross-border settlement orchestrator 102 sends the second electronic confirmation message CONF-2 to the second facilitator system 112 (step 225). In other embodiments, the cross-border settlement orchestrator 102 processes step 225 before step 230. In further embodiments, the cross-border settlement orchestrator 102 processes step 225 and step 230 in a substantially simultaneous manner.

In some embodiments, the first financial transfer system 104 directly sends the first electronic recon message REC-1 (for example, a 5th leg pacs.002 message defined in ISO 20022) to the first facilitator system 108 at step 234. In other examples, the first financial transfer system 104 indirectly sends the first electronic recon message REC-1 to the cross-border settlement orchestrator 102 at step 231. In turn, the first electronic recon message REC-1 is relayed by the cross-border settlement orchestrator 102 to the first facilitator system 108 at step 232.

Similar to the first electronic recon message REC-1 which is sent to the first facilitator system 108, the second electronic recon message REC-2 (for example, a 5th leg pacs.002 message defined in ISO 20022) is sent to the second facilitator system 112. In some examples, the second financial transfer system 114 directly sends the second electronic recon message REC-2 to the second facilitator system 112 at step 238. In other examples, the cross-border settlement orchestrator 102 indirectly sends the second electronic recon message REC-2 to the second facilitator system 112 at step 236, after the cross-border settlement orchestrator 102 receives the first electronic recon message REC-1 from the first financial transfer system 104 as shown in step 231. It is noted that other ways of communicating the first electronic recon message REC-1 and/or the second electronic recon message REC-2 within the system 200 are possible including those described in FIG. 1. In addition to the features discussed above in connection with FIG. 1, additional options as described in connection with FIG. 2 can be implemented either independently or in various combinations.

In some embodiments, the first financial transfer system 104 sends the first electronic recon message REC-1 to the first facilitator system 108 (step 234) before the second financial transfer system 114 sends the second electronic recon message REC-2 to the second facilitator system 112 (step 238). In other embodiments, step 238 is processed before step 234. In further embodiments, step 234 and step 238 are processed in a substantially simultaneous manner.

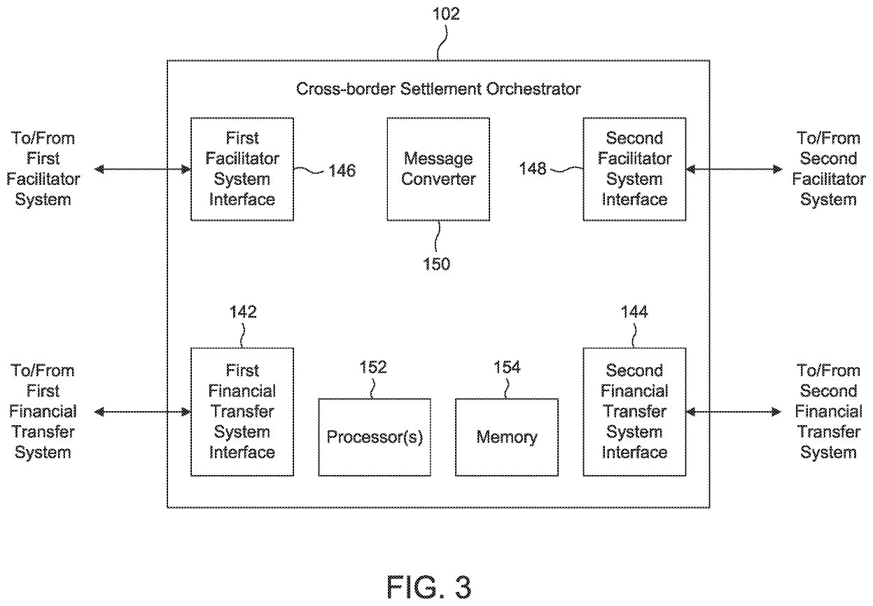

FIG. 3 illustrates an example of the cross-border settlement orchestrator 102 for orchestrating payment systems for immediate cross-border payments. In one embodiment, the cross-border settlement orchestrator 102 includes a first financial transfer system interface 142, a second financial transfer system interface 144, a first facilitator system interface 146, a second facilitator system interface 148, a message converter 150, at least one processor 152, and a memory 154. The first financial transfer system interface 142 is configured to communicate with the first financial transfer system 104. For example, the first financial transfer system interface 142 sends information to and receives information from the first financial transfer system 104. The second financial transfer system interface 144 is configured to communicate with the second financial transfer system 114. For example, the second financial transfer system interface 144 sends information to and receives information from the second financial transfer system 114. The first facilitator system interface 146 is configured to communicate with the first facilitator system 108. For example, the first facilitator system interface 146 sends information to and receives information from the first facilitator system 108. The second facilitator system interface 148 is configured to communicate with the second facilitator system 112. For example, the second facilitator system interface 148 sends information to and receives information from the second facilitator system 112.

The message converter 150 is configured to convert messages received by the cross-border settlement orchestrator 102 via one of the interfaces described above to meet requirements before the cross-border settlement orchestrator 102 send messages out via one of the interfaces described above. For example, the cross-border settlement orchestrator 102 receives the electronic payment message MSG-1 from the first financial transfer system 104 (illustrated and described in FIG. 1) via the first financial transfer system interface 142. In turn, the message converter 150 converts the electronic payment message MSG-1 to the converted electronic payment message CMSG-1 before the cross-border settlement orchestrator 102 sends the converted electronic payment message CMSG-1 to the second financial transfer system 114 via the second financial transfer system interface 144 (illustrated and described in FIG. 1).

The at least one processor 152 performs computations required by operations of the first financial transfer system interface 142, the second financial transfer system interface 144, the first facilitator system interface 146, the second facilitator system interface 148, and the message converter 150. The memory 154 stores instructions required for the at least one processor 152 to perform and other data generated by operations of the first financial transfer system interface 142, the second financial transfer system interface 144, the first facilitator system interface 146, the second facilitator system interface 148, and the message converter 150.

In some examples, the cross-border settlement orchestrator 102 operates and executes instructions required by the operation of the cross-border settlement orchestrator 102 on a single computing device and a single memory device. In other examples, the cross-border settlement orchestrator 102 operates and executes instructions required by the operation of the cross-border settlement orchestrator 102 on a distributed computing environment comprising at least one network server, multiple computing devices, memory devices, and data storages. The network server is configured to be in communication with other components of the distributed computing environment. The first financial transfer system interface 142, the second financial transfer system interface 144, the first facilitator system interface 146, the second facilitator system interface 148, and the message converter 150 can be configured to operate and execute instructions required by their respective operations on any combination of the multiple computing devices and memory devices, and in a number of different sequential or parallel orders.

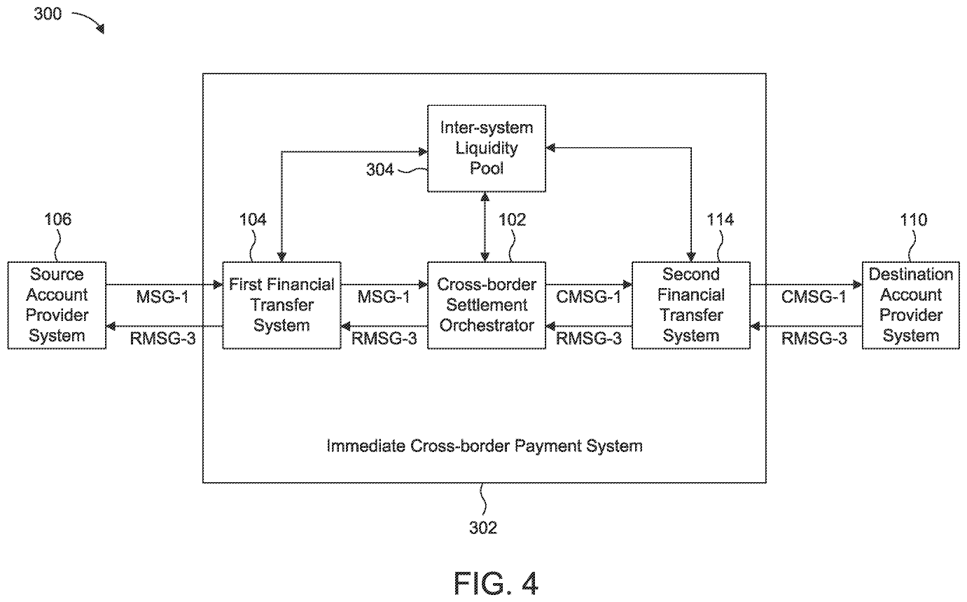

FIG. 4 illustrates an example system 300 for orchestrating payment systems for immediate cross-border payments. In one embodiment, the system 300 includes an immediate cross-border payment system 302, the source account provider system 106, and the destination account provider system 110 (illustrated and described in FIG. 1). The immediate cross-border payment system 302 includes an inter-system liquidity pool 304, the cross-border settlement orchestrator 102, the first financial transfer system 104, and the second financial transfer system interface 144 (illustrated and described in FIG. 1).

In some embodiments, a system for orchestrating financial transfer systems comprises an immediate cross-border payment system which includes a cross-border settlement orchestrator and an inter-system liquidity pool, the cross-border settlement orchestrator configured to be in electronic communication with the inter-system liquidity pool. The inter-system liquidity pool is configured to be accessed by a first facilitator system and a second facilitator system.

In other embodiments, a method for orchestrating financial transfer systems comprises providing liquidity provision by an immediate cross-border payment system using an inter-system liquidity pool configured to be in electronic communication with a cross-border settlement orchestrator. In some examples, the method further comprises accessing the inter-system liquidity pool by a first facilitator system and a second facilitator system.

In further embodiments, there is provided a non-transitory computer-readable medium having stored thereon one or more sequences of instructions, which when executed by one or more processors, cause the one or more processors to perform a method comprising providing liquidity provision by an immediate cross-border payment system using an inter-system liquidity pool configured to be in electronic communication with a cross-border settlement orchestrator. In some examples, the method further comprises accessing the inter-system liquidity pool by a first facilitator system and a second facilitator system.

As described in FIG. 1, the source account provider system 106 is also configured to send the electronic payment message MSG-1 (for instance, a pacs.008 message defined in ISO 20022) to the first financial transfer system 104 in the immediate cross-border payment system 302. In turn, the first financial transfer system 104 sends the electronic payment message MSG-1 to the cross-border settlement orchestrator 102.

Instead of sending the electronic payment message MSG-1 to an external system like the first facilitator system 108 and the second facilitator system 112 (illustrated and described in FIG. 1), the cross-border settlement orchestrator 102 in the immediate cross-border payment system 302 communicates with the inter-system liquidity pool 304. The inter-system liquidity pool 304 is internal to the immediate cross-border payment system 302 and operates to facilitate immediate cross-border transactions. The inter-system liquidity pool 304 is configured to have liquidity provision between the first financial transfer system 104 and the second financial transfer system 114. Also, the inter-system liquidity pool 304 has necessary settlement mechanism between the first financial transfer system 104 and the second financial transfer system 114 for such liquidity. The integration of the inter-system liquidity pool 304 in the immediate cross-border payment system 302 achieves integrated cross-currency settlement and eliminates the need for intermediaries to execute immediate end-to-end cross-border payments.

In some examples, the inter-system liquidity pool 304 is also configured to have a mechanism that determines the amount in a first currency to debit the sending position and the amount in a second currency to credit the receiving position for cross-currency payments. That is, the foreign exchange quote and the calculation of the foreign exchange rate can also be integrated in the inter-system liquidity pool 304.

In other examples, the functionality of the inter-system liquidity pool 304 is achieved using blockchain technology like inter-ledger cryptocurrency, central bank digital currency (CBDC), etc.

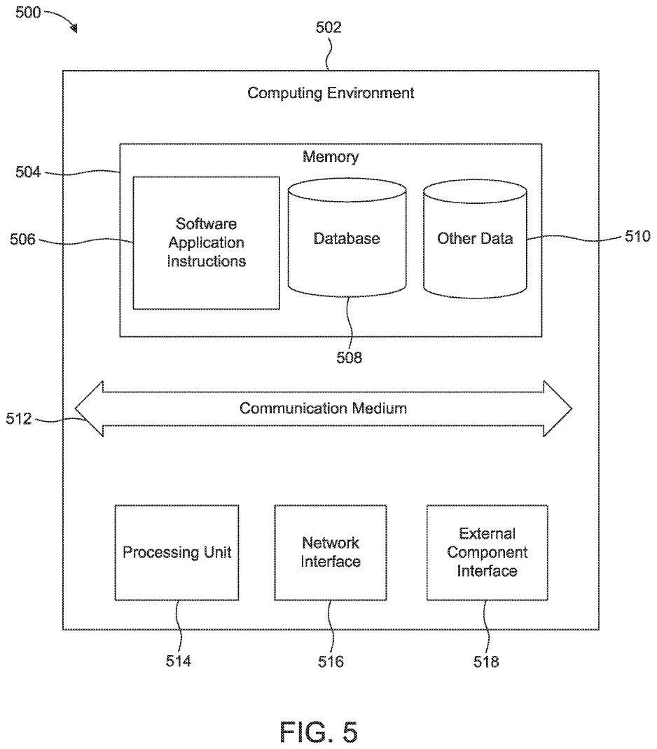

FIG. 5 illustrates an example block diagram of a virtual or physical computing system 500. One or more aspects of the computing system 500 can be used to implement the systems and methods described above in conjunction with FIGS. 1-4, including the cross-border settlement orchestrator 102, the first financial transfer system 104, the source account provider system 106, the first facilitator system 108, destination account provider system 110, the second facilitator system 112, the second financial transfer system 114, and the immediate cross-border payment system 302.

In an example, the computing system 500 can include a computing environment 502. The computing environment 502 can be a physical computing environment, a virtualized computing environment, or a combination thereof. The computing environment 502 can include memory 504, a communication medium 512, one or more processing units 514, a network interface 516, and an external component interface 518.

The memory 504 can include a computer readable storage medium. The computer storage medium can be a device or article of manufacture that stores data and/or computer-executable instructions. The memory 504 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

The memory 504 can store various types of data and software. For example, as illustrated, the memory 504 includes software application instructions 506, one or more databases 508, as well as other data 510.

In addition, the software application instructions 506 can be included in non-transitory computer-readable medium having stored thereon one or more sequences of instructions, which when executed by one or more processors, cause the one or more processors to perform methods or implement systems described above in conjunction with FIGS. 1-4.

The communication medium 512 can facilitate communication among the components of the computing environment 502. In an example, the communication medium 512 can facilitate communication among the memory 504, the one or more processing units 514, the network interface 516, and the external component interface 518. The communication medium 512 can be implemented in a variety of ways, including but not limited to a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communications medium.

The one or more processing units 514 can include physical or virtual units that selectively execute software instructions, such as the software application instructions 506. In an example, the one or more processing units 514 can be physical products comprising one or more integrated circuits. The one or more processing units 514 can be implemented as one or more processing cores. In another example, one or more processing units 514 are implemented as one or more separate microprocessors. In yet another example embodiment, the one or more processing units 514 can include an application-specific integrated circuit (ASIC) that provides specific functionality. In yet another example, the one or more processing units 514 provide specific functionality by using an ASIC and by executing computer-executable instructions.

The network interface 516 enables the computing environment 502 to send and receive data from a communication network. The network interface 516 can be implemented as an Ethernet interface, a token-ring network interface, a fiber optic network interface, a wireless network interface (e.g., Wi-Fi), or another type of network interface.

The external component interface 518 enables the computing environment 502 to communicate with external devices. For example, the external component interface 518 can be a USB interface, Thunderbolt interface, a Lightning interface, a serial port interface, a parallel port interface, a PS/2 interface, or another type of interface that enables the computing environment 502 to communicate with external devices. In various embodiments, the external component interface 518 enables the computing environment 502 to communicate with various external components, such as external storage devices, input devices, speakers, modems, media player docks, other computing devices, scanners, digital cameras, and fingerprint readers.

Although illustrated as being components of a single computing environment 502, the components of the computing environment 502 can be spread across multiple computing environments 502. For example, one or more of instructions or data stored on the memory 504 may be stored partially or entirely in a separate computing environment 502 that is accessed over a network.

Depending on the size and scale of the computing environment 502, it may be advantageous to include one or more load balancers to balance traffic across multiple physical or virtual machine nodes. In an example, the node balancer may be a node balancer product provided by F5 NETWORKS, INC. of Seattle, Washington.

Aspects of the computing system 500 and the computing environment 502 can be protected using a robust security model. In an example, users may be made to sign into the system using a directory service, such as ACTIVE DIRECTORY by MICROSOFT CORPORATION of Redmond, Washington. Connection and credential information can be externalized from jobs using an application programming interface. Credentials can be stored in an encrypted repository in a secured operational data store database space. Privileges can be assigned based on a collaboration team and mapped to a Lightweight Directory Access Protocol (LDAP) Group membership. A self-service security model can be used to allow owners to assign others permissions on their objects (e.g., actions).

Each node may be configured to be capable of running the entirety of the computing system 500, such that portal can run and schedule jobs and serve the portal user interface as long as a single node remains functional. The environment 502 may include monitoring technology to determine when a node is not functioning so an appropriate action can be taken.

In addition, it should be understood that FIGS. 1-5 are presented for example purposes only. The architecture of the example embodiments presented herein is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

1. A system for orchestrating financial transfer systems, comprising: a cross-border settlement orchestrator configured to:
receive an electronic payment message (MSG-1) from a first financial transfer system, the electronic payment message (MSG-1) including a first amount of a first payment in a first currency;
send the electronic payment message (MSG-1) to a first facilitator system;
convert the electronic payment message (MSG-1) to a converted electronic payment message (CMSG-1) according to an exchange rate between the first currency and a second currency, the converted electronic payment message (CMSG-1) including a second amount of a converted payment in the second currency and the converted electronic payment message (CMSG-1) to be communicated to a destination account provider system;
send the converted electronic payment message (CMSG-1) to a second facilitator system;
receive a first electronic response message (RMSG-1) from the first facilitator system and a second electronic response message (RMSG-2) from the second facilitator system, the first electronic response message (RMSG-1) responding to the electronic payment message (MSG-1) sent to the first facilitator system and the second electronic response message (RMSG-2) responding to the converted electronic payment message (CMSG-1) sent to the second facilitator system;
when the first electronic response message (RMSG-1) includes information accepting the electronic payment message (MSG-1) and the second electronic response message (RMSG-2) includes information accepting the converted electronic payment message (CMSG-1), send the converted electronic payment message (CMSG-1) to a second financial transfer system;
receive a third electronic response message (RMSG-3) from the second financial transfer system in response to the converted electronic payment message (CMSG-1);
send a second electronic confirmation message (CONF-2) to the second facilitator system, the second electronic confirmation message (CONF-2) confirming that the second financial transfer system has settled the converted payment;
send the third electronic response message (RMSG-3) to the first financial transfer system, the third electronic response message (RMSG-3) to be communicated to the source account provider system;
receive a first electronic confirmation message (CONF-1) from the first financial transfer system, the first electronic confirmation message (CONF-1) confirming that the first financial transfer system has settled the first payment; and
send the first electronic confirmation message (CONF-1) to the first facilitator system.

2. The system of claim 1, the cross-border settlement orchestrator further configured to cause, by sending the converted electronic payment message (CMSG-1), the destination account provider system to accept the converted payment of the second amount in the second currency, generate the third electronic response message (RMSG-3), and communicate the third electronic response message (RMSG-3) to the second financial transfer system, thereby indicating to the second financial transfer system that the destination account provider system accepts the converted payment of the second amount in the second currency to be settled by the second financial transfer system

3. The system of claim 2, the cross-border settlement orchestrator further configured to cause, by sending the third electronic response message (RMSG-3) to the first financial transfer system, the first financial transfer system to settle the first payment of the first amount in the first currency to the first facilitator system from the source account provider system and send the first electronic confirmation message (CONF-1) to the cross-border settlement orchestrator.

4. The system of claim 1, wherein the electronic payment message (MSG-1) includes a quote for the exchange rate between the first currency and the second currency, the quote having been provided by the first facilitator system to the source account provider system.

5. The system of claim 4, the electronic payment message (MSG-1) further including a token identifying the quote, wherein the token includes the exchange rate between the first currency and the second currency, an expiration date of the quote, and a routing path of the quote, the routing path associating the quote with the first facilitator system and the second facilitator system.

6. The system of claim 1, the cross-border settlement orchestrator further configured to:
receive a first electronic recon message (REC-1) from the first financial transfer system when the first financial transfer system (104) receives the third electronic response message (RMSG-3), the first electronic recon message (REC-1) being configured to acknowledge that the first financial transfer system receives the third electronic response message (RMSG-3) from the cross-border settlement orchestrator;
send the first electronic recon message (REC-1) to the first facilitator system; and
send a second electronic recon message (REC-2) to the second facilitator system upon receiving the third electronic response message (RMSG-3), the second electronic recon message (REC-2) being configured to acknowledge receiving the third electronic response message (RMSG-3) from the second financial transfer system.

7. The system of claim 1, further comprising a liquidity provision system, the liquidity provision system configured to be accessed by the first facilitator system and the second facilitator system.

8. The system of claim 7, wherein the liquidity provision system is accessed by the first facilitator system and the second facilitator system using a blockchain system.

9. A method for orchestrating financial transfer systems, comprising:
receiving, by a cross-border settlement orchestrator, an electronic payment message (MSG-1) from a first financial transfer system, the electronic payment message (MSG-1) including a first amount of a first payment in a first currency;
sending the electronic payment message (MSG-1) to a first facilitator system;
converting the electronic payment message (MSG-1) to a converted electronic payment message (CMSG-1) according to an exchange rate between the first currency and a second currency, the converted electronic payment message (CMSG-1) including a second amount of a converted payment in the second currency and the converted electronic payment message (CMSG-1) to be communicated to a destination account provider system;
sending the converted electronic payment message (CMSG-1) to a second facilitator system;
receiving a first electronic response message (RMSG-1) from the first facilitator system and a second electronic response message (RMSG-2) from the second facilitator system, the first electronic response message (RMSG-1) responding to the electronic payment message (MSG-1) sent to the first facilitator system and the second electronic response message (RMSG-2) responding to the converted electronic payment message (CMSG-1) sent to the second facilitator system;
when the first electronic response message (RMSG-1) includes information accepting the electronic payment message (MSG-1) and the second electronic response message (RMSG-2) includes information accepting the converted electronic payment message (CMSG-1), sending the converted electronic payment message (CMSG-1) to a second financial transfer system;
receiving a third electronic response message (RMSG-3) from the second financial transfer system in response to the converted electronic payment message (CMSG-1);
sending a second electronic confirmation message (CONF-2) to the second facilitator system, the second electronic confirmation message (CONF-2) confirming that the second financial transfer system has settled the converted payment;
sending the third electronic response message (RMSG-3) to the first financial transfer system, the third electronic response message (RMSG-3) to be communicated to the source account provider system;
receiving a first electronic confirmation message (CONF-1) from the first financial transfer system, the first electronic confirmation message (CONF-1) confirming that the first financial transfer system (104) has settled the first payment; and
sending the first electronic confirmation message (CONF-1) to the first facilitator system

10. The method of claim 9, further comprising:
sending, by the cross-border settlement orchestrator, the converted electronic payment message (CMSG-1) to cause the destination account provider system to accept the converted payment of the second amount in the second currency, generate the third electronic response message (RMSG-3), and communicate the third electronic response message (RMSG-3) to the second financial transfer system, thereby indicating to the second financial transfer system that the destination account provider system accepts the converted payment of the second amount in the second currency to be settled by the second financial transfer system.

11. The method of claim 10, further comprising:
sending, by the cross-border settlement orchestrator-, the third electronic response message (RMSG-3) to cause the first financial transfer system to settle the first payment of the first amount in the first currency to the first facilitator system from the source account provider system, and send the first electronic confirmation message (CONF-1) to the cross- border settlement orchestrator.

12. The method of claim 9, wherein the electronic payment message (MSG-1) includes a quote for the exchange rate between the first currency and the second currency, the quote having been provided by the first facilitator system to the source account provider system.

13. The method of claim 12, the electronic payment message (MSG-1) further including a token identifying the quote, wherein the token includes the exchange rate between the first currency and the second currency, an expiration date of the quote, and a routing path of the quote, the routing path associating the quote with the first facilitator system and the second facilitator system.

14. The method of claim 9, further comprising:
receiving, by the cross-border settlement orchestrator, a first electronic recon message (REC-1) from the first financial transfer system when the first financial transfer system receives the third electronic response message (RMSG-3), the first electronic recon message (REC-1) being configured to acknowledge that the first financial transfer system receives the third electronic response message (RMSG-3) from the cross-border settlement orchestrator;
sending, by the cross-border settlement orchestrator, the first electronic recon message (REC-1) to the first facilitator system; and
sending, by the cross-border settlement orchestrator, a second electronic recon message (REC-2) to the second facilitator system upon receiving the third electronic response message (RMSG-3), the second electronic recon message (REC-2) being configured to acknowledge receiving the third electronic response message (RMSG-3) from the second financial transfer system.

15. The method of claim 9, further comprising accessing a liquidity provision system by the first facilitator system and the second facilitator system.

16. The method of claim 15, wherein the liquidity provision system is accessed by the first facilitator system and the second facilitator system using a blockchain system.

17. A non-transitory computer-readable medium having stored thereon one or more sequences of instructions, which when executed by one or more processors, cause the one or more processors to perform:
receiving, by a cross-border settlement orchestrator, an electronic payment message (MSG-1) from a first financial transfer system, the electronic payment message (MSG-1) including a first amount of a first payment in a first currency;
sending the electronic payment message (MSG-1) to a first facilitator system;
converting the electronic payment message (MSG-1) to a converted electronic payment message (CMSG-1) according to an exchange rate between the first currency and a second currency, the converted electronic payment message (CMSG-1) including a second amount of a converted payment in the second currency and the converted electronic payment message (CMSG-1) to be communicated to a destination account provider system;
sending the converted electronic payment message (CMSG-1) to a second facilitator system;
receiving a first electronic response message (RMSG-1) from the first facilitator system and a second electronic response message (RMSG-2) from the second facilitator system, the first electronic response message (RMSG-1) responding to the electronic payment message (MSG-1) sent to the first facilitator system and the second electronic response message (RMSG-2) responding to the converted electronic payment message (CMSG-1) sent to the second facilitator system;
when the first electronic response message (RMSG-1) includes information accepting the electronic payment message (MSG-1) and the second electronic response message (RMSG-2) includes information accepting the converted electronic payment message (CMSG-1), sending the converted electronic payment message (CMSG-1) to a second financial transfer system;
receiving a third electronic response message (RMSG-3) from the second financial transfer system in response to the converted electronic payment message (CMSG-1);
sending a second electronic confirmation message (CONF-2) to the second facilitator system, the second electronic confirmation message (CONF-2) confirming that the second financial transfer system has settled the converted payment;
sending the third electronic response message (RMSG-3) to the first financial transfer system, the third electronic response message (RMSG-3) to be communicated to the source account provider system;
receiving a first electronic confirmation message (CONF-1) from the first financial transfer system, the first electronic confirmation message (CONF-1) confirming that the first financial transfer system has settled the first payment; and sending the first electronic confirmation message (CONF-1) to the first facilitator system.

18. The non-transitory computer-readable medium of claim 17, having stored thereon one or more sequences of instructions, which when executed by one or more processors, cause the one or more processors to further perform:
sending the converted electronic payment message (CMSG-1) to cause the destination account provider system to accept the converted payment of the second amount in the second currency, generate the third electronic response message (RMSG-3), and communicate the third electronic response message (RMSG-3) to the second financial transfer system, thereby indicating to the second financial transfer system that the destination account provider system- accepts the converted payment of the second amount in the second currency to be settled by the second financial transfer system; and
sending the third electronic response message (RMSG-3) to cause the first financial transfer systemto settle the first payment of the first amount in the first currency to the first facilitator system from the source account provider system and reply with the first electronic confirmation message (CONF-1).

19. The non-transitory computer-readable medium of claim 17, having stored thereon one or more sequences of instructions, which when executed by one or more processors, cause the one or more processors to further perform:
receiving a first electronic recon message (REC-1) from the first financial transfer system when the first financial transfer system receives the third electronic response message (RMSG-3), the first electronic recon message (REC-1) being configured to acknowledge that the first financial transfer system receives the third electronic response message (RMSG-3);
sending the first electronic recon message (REC-1) to the first facilitator system; and
sending a second electronic recon message (REC-2) to the second facilitator system upon receiving the third electronic response message (RMSG-3), the second electronic recon message (REC-2) being configured to acknowledge receiving the third electronic response message (RMSG-3) from the second financial transfer system.

20. The non-transitory computer-readable medium of claim 17, having stored thereon one or more sequences of instructions, which when executed by one or more processors, cause the one or more processors to further perform accessing a liquidity provision system using a blockchain system.
